(19) United States
(12) Patent Application Publication
(10) Pub. No.: US 2011/0055315 A1
(43) Pub. Date: Mar. 3, 2011

(54) System and Method for Providing Connections Between Devices on a Network

(75) Inventor: Michael Sanford, Reston, VA (US)

(73) Assignee: Flipside5, Inc.

(21) Appl. No.: 12/553,719

(22) Filed: Sep. 3, 2009

(51) Int. Cl. G06F 15/16; G06F 3/033

(52) U.S. Cl. 709/203; 709/227; 715/863

(57) ABSTRACT

In various implementations of the invention, a user of a computing device provides a single input to connect to another computing device to play an interactive game over a client-server network, such as a local area network or personal network. In various implementations of the invention, the computing device identifies itself to the network as both a client and a server with respect to the interactive game. A second computing device operates similarly to ultimately establish a single communication session between the two computing devices over which the interactive game is played.

### TECHNICAL FIELD

The disclosure relates generally to a connecting devices over a network and more specifically, connecting two mobile devices to one another over a network that employs a client/server protocol.

### BACKGROUND

Various conventional protocols exist that enable devices to connect to one another over a network. Some protocols, such as those employed by local area networks or personal networks employ a “client-server” metaphor where one device is designated as a client and another device is designated as a server. In some environments, this is relatively useful such as, for example, when a computing device connects to a peripheral device such as a printer. In this example, the peripheral device is predetermined as the server and the computing device is predetermined as the client. A user of the computing device need only specify its desire to connect to the peripheral device and a connection over the network is made.

However, when one computing device connects to another computing device, the process is not as simple. Often times in these situations, neither computing device is predetermined as a client or as a server or more typically, both computing devices are considered clients as opposed to servers. In order to establish a connection between these two computing devices, some degree of negotiation is required either between the computing devices, or the users of the computing devices, to establish which computing device will be the client and which computing device will be the server.

In some environments, this negotiation provides an undesirable user experience and may ultimately discourage users from frequently connecting their computing devices to those of other users to, for example, play an on-line game with the other user(s).

What are needed are improved systems and methods for connecting computing devices to one another over a network that utilizes a client-server protocol.

### OVERVIEW

In various implementations of the invention, a user of a computing device (e.g., a mobile computing device) provides a single input to connect to another computing device to operate an application (e.g., play an interactive game) over a client-server network (e.g., a local area network or personal network). In various implementations of the invention, the computing device identifies itself to the network as both a client and a server with respect to the interactive game. A second computing device operates similarly and ultimately a single communication session between the two computing devices is established, over which the application is facilitated. In some implementations of the invention, this process is referred to as a “one touch connect” process over the client-server network. In various implementations of the invention, this is accomplished via a service discovery tool.

Some implementations of the invention include receiving, at a first computing device, a first input from a first user of the first computing device, the first input indicative of a desire of the first user to initiate an application with another computing device; in response to the first input, identifying, by the first computing device to the network, the first computing device as both a client device and a server device available to run the application; receiving at the first computing device an established session between the first computing device and a second computing device, the established session for handling interactions between the first computing device and the second computing device in connection with the application; and communicating with the second computing device over the established session during the application. Some implementations of the invention further include receiving, at a second computing device, a second input from a second user of the second computing device, the second input indicative of a desire of the second user to initiate the application with another device; in response to the second input, identifying, by the second computing device to the network, the second computing device as both a client device and a server device available to run the application; and receiving at the second computing device the established session between the first computing device and the second computing device.

### BRIEF DESCRIPTION OF THE DRAWINGS

The accompanying drawings, which are incorporated into and constitute a part of this specification, illustrate one or more examples of implementations of the invention and, together with the description, serve to explain various principles and aspects of the invention.

FIG. 1 illustrates an exemplary environment useful for describing various aspects and/or implementations of the invention.

FIG. 2 illustrates a block diagram of computing device that may be used in various implementations of the invention.

FIG. 3 illustrates a graphical user interface that may be used in connection with a computing device according to various implementations of the invention.

FIG. 4 is a flowchart illustrating an operation of various implementations of the invention.

Reference will now be made in detail to various implementations of the invention as illustrated in the accompanying drawings. The same reference indicators will be used throughout the drawings and the following description to refer to the same or like items.

### DESCRIPTION OF EXEMPLARY IMPLEMENTATIONS

Conventionally, when a first user desires to connect its computing device to a computing device of a second user, the first user must initiate a communication with the second user. Often, this communication may be an out-of-band communication, such as an email, a phone call, a text message, in-person verbal exchange or other out-of-band communication. During this communication, the first user and the second user negotiate which of their respective computing devices will be designated a client and which will be designated a server. Based on this negotiation, one of the users initiates a network connection in which this user's computing device is designated a server. This user must then notify the other user that the server has been started. The other user then designates its computing device as a client and the two devices connect to one another via the network connection.

For example, in an on-line gaming environment, where the first user wishes to play the second user in a game such as tic-tac-toe using the users' respective computing devices, the first user may contact the second user and the two of them agree to play tic-tac-toe. The first user agrees to “host the game” (i.e., be designated the server) via, for example, a first button in a user interface and the second user agrees to “join the game” (i.e., be designated the client) via, for example, a second button on the user interface. Other labels may be used to specify which user is designated server and which is designated client as would be appreciated. Once one computing device is designated as the client and the other is designated as the server, various well-established connection protocols connect the two computing devices together for playing the game.

As thus described, connecting computing devices over a local area network, personal network or other client-server network in a conventional manner is generally inconvenient from the perspective of the users' experience.

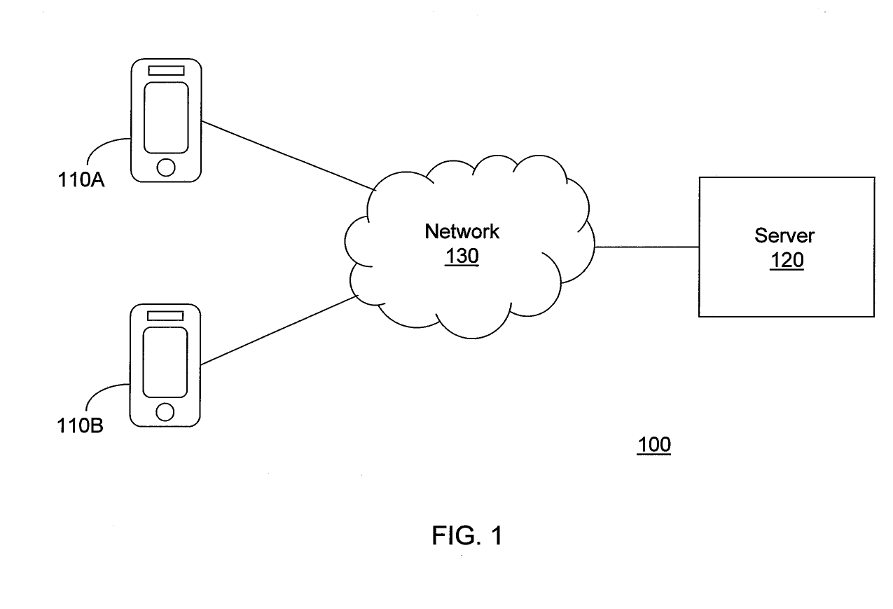

FIG. 1 illustrates an exemplary environment 100 useful for describing various aspects and/or implementations of the invention. Exemplary environment 100 includes a first computing device 110A, a second computing device 110B (which are referred to herein generically as a computing device 110), and a server 120 which are collectively coupled, or capable of being coupled, together via a network 130.

In some implementations, computing device 110 is a mobile computing device 110. In some implementations of the invention, computing device 110 is a wireless mobile computing device 110. In some implementations of the invention, computing device 110 is a handheld mobile computing device 110. In some implementations of the invention, computing device 110 is an iPhone™, manufactured by Apple, Inc. Although computing devices 110 are illustrated in FIG. 1 as being of identical or similar type, computing device 110A may have a type different from that of computing device 110B.

In some implementations of the invention, network 130 is client-server network 130, or in other words, a network that utilizes a client-server metaphor. In some implementations of the invention, network 130 is a local area network 130. In some implementations of the invention, network 130 is a personal area network 130.

In some implementations of the invention, network 130 employs one or more wireless links 140 that facilitate the coupling of computing devices 110 to each other and/or to server 120, and/or to other devices (not otherwise illustrated).

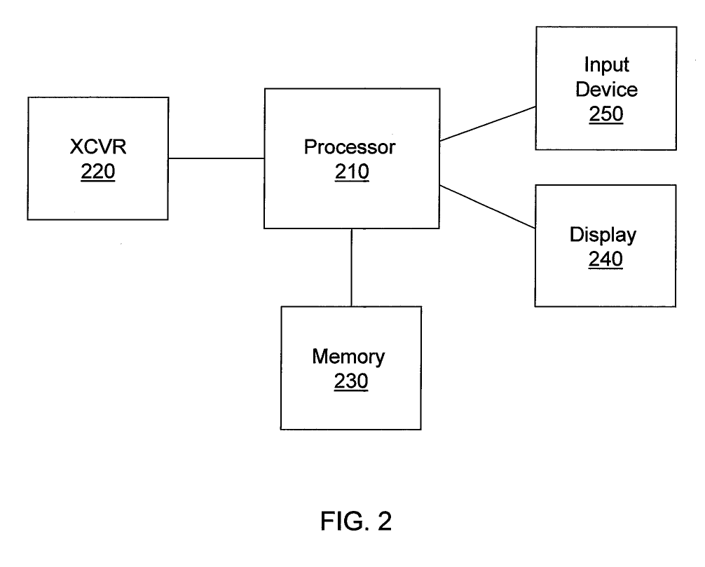

FIG. 2 illustrates a block diagram of computing device 110. Computing device 110 includes a processor 210, a transceiver 220, a memory 230, a display 240, and an input device 250. In some implementations of the invention, memory 230 includes software instructions that when run on processor 210, cause processor 210 to operate in a particular manner. In some implementations of the invention, input device 250 is integrated with display 240 to form a “touch screen” as would be appreciated.

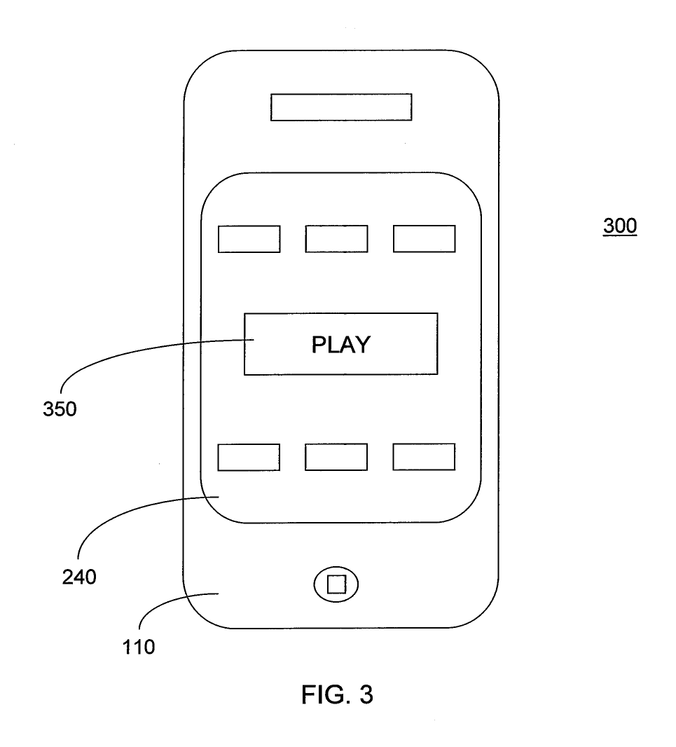

FIG. 3 illustrates an image of a graphical user interface (“GUI”) 300, which is displayed on a display of computing device 110, that is useful for describing various implementations of the invention. As illustrated in FIG. 3, GUI 300 is displayed on the touch screen of an iphone. GUI 300 includes various GUI elements including, but not limited to a “connect” button 350.

According to various implementations of the invention, when a first user wishes to connect first computing device 110A to another computing device 110 (e.g., second computing device 110B), the first user actuates “connect” button 350 on GUI 300 via input device 250 of first computing device 110A. As would be appreciated, various other labels may be applied to connect button 350, such as, but not limited to, “play,” “play game,” “start,” “start game,” and other labels. In response to the first user actuating connect button 350, first computing device 110A initiates a connect request on network 130. Similarly, when a second user of second computing device 110B wishes to connect to another computing device (e.g., first computing device 110B), the second user actuates connect button 350 on GUI 300 via input device 250 of second computing device 110B. In response to the second user actuating connect button 350, second computing device 110B initiates a connect request on network 130. In some implementations of the invention, server 130 receives the connect request from first computing device 110A and matches it to the connect request from second computing device 110B.

After this matching, in some implementations of the invention, two connections exist, or are otherwise established, between first computing device 110A and second computing device 110B. In some implementations, server 130 drops one of the connections between first computing device 110A and second computing device 110B. In some implementations, server 130 causes one of the connections between first computing device 110A and second computing device 110B to be dropped. In some implementations, first computing device 110A drops one of the connections to second computing device 110B. In some implementations, second computing device 110A drops one of the connections to first computing device 110B. In some implementations, a first one of the computing devices 110 to act drops one of the connections to the other computing device 110. In some implementations, a first one of the computing devices 110 to act causes one of the connections to the other computing device 110 to drop.

According to various implementations of the invention, in response the first user actuating connect button 350, first computing device 110A initiates a first communication session over network 130 employing a client-server protocol. Similarly, in response to the second user actuating connect button 350, second computing device 110B initiates a second communication session over network 130 employing a client-server protocol. According to various implementations of the invention, the first communication session, and/or data associated therewith, designates or otherwise identifies first computing device 110A as both a “client” and a “server.” Similarly, the second communication session, and/or data associated therewith, designates or otherwise identifies second computing device 110B as both a “client” and a “server.” According to various implementations of the invention, server 130 receives information identifying the first communication session, receives information identifying the second communication session, and matches the two together. In some implementations of the invention, server 130 replaces one or more designations in the first communication session and the second communication session such that: 1) in the first communication session, first computing device 110A corresponds to the “client” and second computing device 110B corresponds to the “server”; and 2) in the second communication session, first computing device 110A corresponds to the “server” and second computing device 110B corresponds to the “client”. In some implementations, server 130 replaces one or more designations in the first communication session and the second communication session such that, in both the first and the second communication sessions, first computing device 110A corresponds to the “client” and second computing device 110B corresponds to the “server”. In some implementations, server 130 replaces one or more designations in the first communication session and the second communication session such that, in both the first and the second communication sessions, second computing device 110A corresponds to the “client” and first computing device 110B corresponds to the “server”.

After being matched by server 130, in some implementations of the invention, two communication sessions are established between first computing device 110A and second computing device 110B, namely first communication session and second communication session. In some implementations of the invention, first computing device 110A drops or otherwise terminates one of the communications sessions. In some implementations of the invention, second computing device 110B drops or otherwise terminates one of the communications sessions.

After this matching, in some implementations of the invention, two connections exist, or are otherwise established, between first computing device 110A and second computing device 110B. In some implementations, server 130 drops one of the connections between first computing device 110A and second computing device 110B. In some implementations, server 130 causes one of the connections between first computing device 110A and second computing device 110B to be dropped. In some implementations, first computing device 110A drops one of the connections to second computing device 110B. In some implementations, second computing device 110A drops one of the connections to first computing device 110B. In some implementations, a first one of the computing devices 110 to act drops one of the connections to the other computing device 110. In some implementations, a first one of the computing devices 110 to act causes one of the connections to the other computing device 110 to drop.

Various tools or protocols operable on and with network 130 may be used to implement various functions and aspects of the invention. Some of such tools operate to discover services on network 130. Such service discovery tools are generally well known. When network 130 corresponds to a local area network, one such service discovery tool is Bonjour™ (formerly known as Rendezvous™) offered by Apple Inc. This, and other service discovery tools, may be used to locate various devices on network 130, including peripherals and computing devices, as well as any services offered on network 130 by such devices. By their nature, such service discovery tools typically require a client-server connection. However, from the perspective of the user experience, a peer-to-peer connection would appear to be more appropriate. According to various implementations of the invention, the service discovery tool may be used to mimic this peer-to-peer connection.

In some implementations of the invention, in response the first user actuating connect button 350, first computing device 110A utilizes a service discovery tool to identify itself to network 130 as a service available to run a particular application, such as, but not limited to, an interactive, multiplayer game. In doing so, first computing device 110A indentifies itself as both a client and a server. Similarly, in response to the second user actuating connect button 350, second computing device 110B utilizes the same or a similar service discovery tool to identify itself to network 130 as a service available to run the particular application. In doing so, second computing device 110B identifies itself as both a client and a server. According to various implementations of the invention, the services associated with the particular application are matched with one another, and connections associated with each service (in this example, two connections) are established between first computing device 110A and second computing device 110B. As discussed above, one of the connections is dropped and the particular application is run between first computing device 110A and second computing device 110B over the remaining connection with one of computing devices 110 acting as a client and the other computing device 110 acting as a server.

In some implementations of the invention, the service discovery tool performs this matching. In these implementations, the service discovery tool scans open ports on network 130 and creates a connection between two or more services that identify the same particular application. In some implementations, the service discovery tool includes a background service that communicates through a designated port to perform the matching or “rendevous” of the services.

In some implementations of the invention, the service discovery tool performs the matching based on various parameters. In some implementations, the matching is based on a physical proximity between first computing device 110A and second computing device 110B. This physical proximity may be determined based on information pertaining to network addresses of computing devices, a point of connection of computing devices 110 to network 130, a GPS location via of each computing device 110, and other mechanisms for determining physical proximity between computing devices 110. In some of these implementations, users in close physical proximity to one another may, for example, play one another on a multiplayer interactive game.

In some implementations of the invention, the matching is based on a first available computing device 110 with a request to initiate the same application as first computing device 110A. In some of these implementations, users may play a first available user interested in, for example, playing the same multiplayer interactive game.

In some implementations of the invention, the matching is based on an identification of another user (or a computing device 110 of the another user) with which the first user wishes to play.

In some implementations of the invention, other parameters may be utilized perform the matching as would be appreciated.

In some implementations of the invention, information associated with one or more parameters that specify how matching is to be performed may be provided to service discovery tool as would be appreciated.

From the perspective of the user, after the user actuates connect button 350, in some implementations of the invention, the user may be provided with a status that indicates that another participant for the particular communication session or particular application is being sought. Once that other participant is identified (i.e., once the respective services are matched), the user may be provided with a status that indicates that a participant as been located, the communication session has been established and/or that the particular application is ready to run.

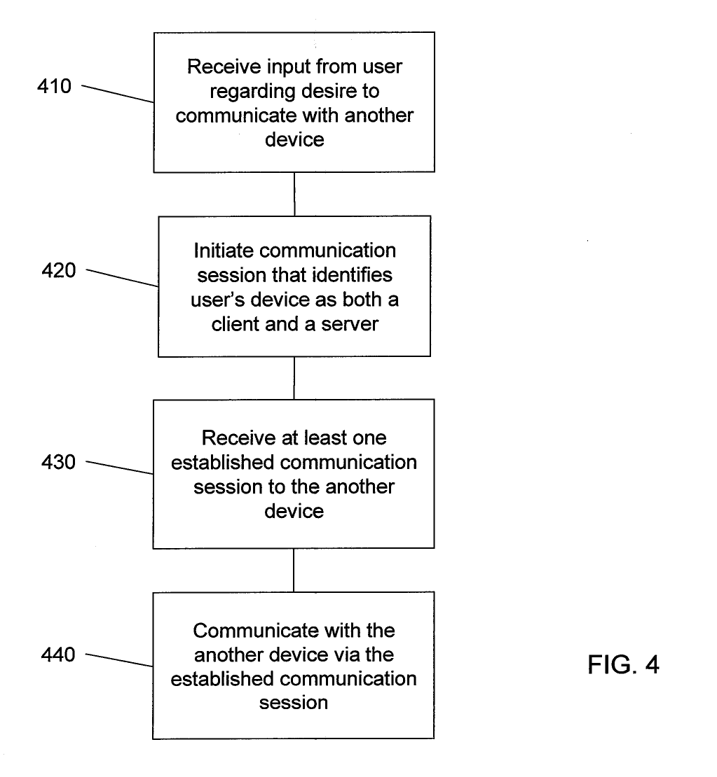

FIG. 4 is a flowchart illustrating an operation of various implementations of the invention. In an operation 410, a computing device 110 receives an input from a user indicating the users' desire to communicate with another computing device 110. In some implementations of the invention, for example, the user actuates connect button 350 as discussed above. Other mechanisms may be used as would be appreciated.

In an operation 420, in response to receiving the input from the user, computing device 110 initiates a communication session that designates computing device 110 as both a host device and as a client device.

In some implementations of the invention, similar operations to operation 410 and 420 are performed by another computing device 110 as described above.

In an operation 430, computing device 110 receives at least one established communication session (and/or information pertaining to such session) between computing device 110 and another computing device 110. In some implementations of the invention, computing device 110 receives a first communication session initiated by computing device 110 and a second communication session initiated by the another computing device 110. In some implementations of the invention, one of these two communication sessions is dropped as described above, leaving a single established communication session.

In an operation 440, computing device 110 communicates with the another computing device 110 via the established communication session.

Although various examples and implementations of the invention are described herein in the context of connecting computing devices, including mobile computing devices, over a local area network, personal network, or other network utilizing a client-server protocol for purposes of game play, the invention is not so limited. The following description is illustrative only and is not intended to be limiting in any way. Other computing devices and/or computing environments and implementations thereof will readily suggest themselves to persons skilled in the art having the benefit of this disclosure.

In the interest of clarity, not all of the routine features of the implementations described herein are illustrated and described. It will, of course, be appreciated that in the development of any such actual implementation, numerous implementation-specific decisions must be made in order to achieve the developer's specific goals, such as compliance with application- and business-related constraints, and that these specific goals will vary from one implementation to another and from one developer to another. Moreover, it will be appreciated that such a development effort might be complex and time-consuming, but would nevertheless be a routine undertaking of engineering for those of ordinary skill in the art having the benefit of this disclosure. Furthermore, various combinations of various ones of the features disclosed herein may be made as would be apparent even though such combinations are not expressly described herein.

In accordance with this disclosure, those of ordinary skill in the art will recognize that devices of a less general purpose nature, such as hardwired devices, field programmable gate arrays (FPGAs), application specific integrated circuits (ASICs), or the like, may also be used without departing from the scope and spirit of the inventive concepts disclosed herein. Where a method comprising a series of process steps is implemented by a computer or a machine and those process steps can be stored as a series of instructions readable by the machine, they may be stored on a tangible storage medium such as a computer memory device (e.g., ROM (Read Only Memory), PROM (Programmable Read Only Memory), EEPROM (Electrically Eraseable Programmable Read Only Memory), FLASH Memory, Jump Drive, and the like), magnetic storage medium (e.g., tape, magnetic disk drive, and the like), optical storage medium (e.g., CD-ROM, DVD-ROM, paper card, paper tape and the like) and other types of storage media.

While various implementations and applications have been shown and described, it would be apparent to those skilled in the art having the benefit of this disclosure that many more modifications than mentioned above are possible without departing from the inventive concepts disclosed herein. The invention, therefore, is not to be restricted except in the spirit of the following claims.

What is claimed is:

1. A method for connecting mobile devices comprising:
receiving, at a first mobile device, a first input from a first user of the first mobile device, the first input indicative of a desire of the first user to communicate with another mobile device;
in response to the first input, initiating, from the first mobile device, a first communication session that designates the first mobile device as both a host device and as a client device;
receiving, at a second mobile device, a second input from a second user of the second mobile device, the second input indicative of a desire of the second user to communicate with another mobile device;
in response to the second input, initiating, from the second mobile device, a second communication session that designates the second mobile device as both a host device and a client device;
receiving at the first mobile device an established communication session between the first mobile device and the second mobile device, the established communication session corresponding to either the first communication session or the second communication session, the established communication session including information that identifies the first mobile device as either the host device or the client device;
receiving at the second mobile device the established communication session between the first mobile device and the second mobile device, the established communication session including information that identifies the second mobile device as either the host device or the client device and opposite of the first mobile device;
discarding either the first communication session or the second communication session that does not correspond to the established communication session; and
communicating over the established communication session.

2. The method of claim 1, wherein receiving, at a first mobile device, a first input from a first user of the first mobile device comprises receiving a single first input from the first user as indicative of the desire of the first user to communicate with another mobile device.

3. The method of claim 2, wherein receiving a single first input from the first user as indicative of the desire of the first user to communicate with another mobile device comprises receiving only the single first input from the first user as indicative of the desire of the first user to communicate with another mobile device.

4. The method of claim 2, wherein receiving a single first input from the first user comprises receiving a touch, a gesture, an utterance, or a key stroke from the first user.

5. The method of claim 2, wherein receiving, at a second mobile device, a second input from a second user of the second mobile device comprises receiving a single second input from the second user as indicative of the desire of the second user to communicate with another mobile device.

6. The method of claim 3, wherein receiving a single second input from the second user as indicative of the desire of the second user to communicate with the second other mobile device comprises receiving only the single second input from the second user as indicative of the desire of the second user to communicate with another mobile device.

7. The method of claim 1, wherein receiving, at a first mobile device, a first input from a first user of the first mobile device, the first input indicative of a desire of the first user to communicate with another mobile device, comprises receiving, at the first mobile device, the first input from the first user of the first mobile device, the first input indicative of a desire of the first user to initiate play of a game with another mobile device.

8. The method of claim 1, wherein initiating, from the first mobile device, a first communication session that designates the first mobile device as both a host device and as a client device comprises initiating the first communication session over a local area network.

9. A method for connecting devices over a network comprising:
receiving, at a first mobile device, a first input from a first user of the first device, the first input indicative of a desire of the first user to communicate with another device;
in response to the first input, initiating, from the first device, a first communication session that designates the first device as both a host device and as a client device;
receiving at the first device an established communication session between the first device and the another device, the established communication session corresponding to either the first communication session or a second communication session initiated by the another device, the established communication session including information that identifies the first device as either the host device or the client device;
if the information identifies the first device as the client device, discarding the first communication session; and
communicating over the established communication session.

10. A method for connecting computing devices over a network comprising:
receiving, at a first computing device, a first input from a first user of the first computing device, the first input indicative of a desire of the first user to initiate an application with another computing device;
in response to the first input, identifying, by the first computing device to the network, the first computing device as both a client device and a server device available to run the application; and
receiving at the first computing device an established session between the first computing device and a second computing device, the established session for handling interactions between the first computing device and the second computing device in connection with the application; and
communicating with the second computing device over the established session during the application.

11. The method of claim 10, further comprising:
receiving, at a second computing device, a second input from a second user of the second computing device, the second input indicative of a desire of the second user to initiate the application with another device;
in response to the second input, identifying, by the second computing device to the network, the second computing device as both a client device and a server device available to run the application; and
receiving at the second computing device the established session between the first computing device and the second computing device.
